(19) United States
(12) Patent Application Publication
(10) Pub. No.: US 2010/0321597 A1
(43) Pub. Date: Dec. 23, 2010

(54) PROJECTION SYSTEM

(76) Inventors: Jiun-Shiun Wang, Hsinchu (TW); Sze-Ke Wang, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 12/853,316

(22) Filed: Aug. 10, 2010

Related U.S. Application Data
(62) Division of application No. 11/775,862, filed on Jul. 10, 2007.

(30) Foreign Application Priority Data
Aug. 25, 2006 (TW) 095131319

(51) Int. Cl. G02F 1/1335; G03B 21/28

(52) U.S. Cl. 349/5; 353/98

(57) ABSTRACT

A projection system includes an illumination apparatus, an imaging apparatus, and a projection lens. The illumination apparatus includes a light source, a lens array, light collecting elements, and a converging lens array. The light source provides a parallel light beam. The light collecting elements are disposed at a side of the lens array, and arranged in an array. Each light collecting element has a second end facing the light source, a first end corresponding to the second end, and at least one side connected between the first end and the second end. Each light collecting element shrinks from its second end to its first end. The side of the light collecting element has at least one reflective surface. The converging lens array scales the light beam exiting the light collecting element. The imaging apparatus forms an image from the light beam. The projection lens projects the image to a surface.

### CROSS REFERENCE TO RELATED APPLICATIONS

This application is a divisional of U.S. patent application Ser. No. 11/775,862 filed 10 Jul., 2007, which is incorporated herein by reference.

### BACKGROUND OF THE INVENTION

1. Field of the Invention

The invention relates to a projection system, and more particularly, to a projection system with a light collecting element.

2. Description of the Prior Art

Please refer to FIG. 1. A digital light processing (DLP) projector system 10 of the prior art includes a light source 12, a reflector 14, a rectangular-prism-shaped rod integrator 20, a converging lens array 16, an imaging apparatus 18, and a projection lens 30. A light beam emitted by the light source 12 is converged by the reflector 14, which is positioned around the light source 12, and transmits to an incident end of the rod integrator 20, which homogenizes the light beam. After the light beam is homogenized, the light beam is transmitted from an exit end 22 of the rod integrator 20, at an angle equal to an incident angle at which the light beam entered the incident end 21, to the converging lens array 16. The light beam is then scaled by the converging lens array 16, and projected to the imaging apparatus 18. Finally, an image formed after processing in the imaging apparatus 18 is projected onto a screen (not shown) through the projection lens 30. The imaging apparatus 18 could be a Texas Instruments (TI) digital micromirror device (DMD), which transforms the light beam into an image beam. The imaging apparatus 18 only has a limited receiving angle, so the imaging apparatus 18 can only receive incident light sent at a certain angle from the converging lens array 16.

However, because the light beams from the light source 12 and sent to the incident end 21 of the rod integrator 20 are not an ideal light source, as shown in FIG. 2, other than the light beams which enter a cross-section of the incident end 21, a lot of light beams 23 are unable to enter the incident end 21, and are wasted. Thus, to improve this condition, as shown in FIG. 3, another prior art technology is adopted which uses two different elliptical parameters in a reflector 141. Although this structure is able to project most of the light beams effectively to the incident end 21 of the rod integrator 20, but a major drawback of this structure is a very high cost of manufacture of the reflector 141. Another technology shown in FIG. 4 is also used to improve the condition shown in FIG. 2. As shown in FIG. 4, a rod integrator 201 has a different shape, such that an incident end 211 has a larger cross-sectional area than an exit end 221 of the rod integrator 201. In this way, the incident end 211 can absorb more light beams than the incident end 21, however because internal reflecting walls of the rod integrator 201 change the angle of the light beams, the angle of a portion of the light beams leaving the exit end 221 will be greater than the incident angle of the light beams when the light beams entered the rod integrator 201. Further, the light beam with the greater angle cannot be fully used by and projected to the imaging apparatus 18, which leads again to waste of the light beam. Another rod integrator 202 shown in FIG. 5 is disclosed in U.S. Pat. No. 6,715,880. The rod integrator 202 has a larger incident end 212, which is shaped like a chopped off pyramid to allow more light beam to enter the rod integrator 202, be reflected by interior walls of the rod integrator 202, and exit through an exit end 222. Because the light beam is focused at the incident end 212, when the light beam is focused to reflect in the integrating rod 202, in order to cause the light beam to pass through the exit end 222 at an appropriate angle, the exit end 222 must also have an outwardly expanding shape to change the angle the light exits at, so as to make the extra light beam absorbed by the pyramid-shaped incident end 212 available for use at the imaging apparatus 18. However, this rod integrator 202 is more difficult to manufacture due to its special shape.

### SUMMARY OF THE INVENTION

According to an embodiment, a projection system includes an illumination apparatus, an imaging apparatus, and a projection lens. The illumination apparatus includes a light source for providing a parallel light beam, a lens array, a plurality of light collecting elements, and a converging lens array. The light collecting elements are disposed at a side of the lens array away from the light source. The light collecting elements are arranged in an array corresponding to the lens array, each light collecting element having a second end facing the light source, a first end corresponding to the second end, and at least one side connected between the first end and the second end. Each light collecting element shrinks from the second end to the first end. The side of the light collecting element has at least one reflective surface for reflecting a portion of the light beam entering the light collecting element. The converging lens array is for scaling the light beam exiting the light collecting element. The imaging apparatus is for receiving the light beam scaled by the converging lens array and forming an image. The projection lens is for projecting the image to a surface.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a DLP projection system according to the prior art.

FIG. 2 is a diagram of light incident on an incident end of a rod integrator according to the prior art.

FIG. 3 is a diagram of a light source according to the prior art.

FIG. 4 is a diagram of a second light source according to the prior art.

FIG. 5 is a diagram of a rod integrator according to the prior art.

FIG. 6 is a diagram of a projection system according to a preferred embodiment of the invention.

FIG. 7 is a perspective view and a front view of a light collecting element of the invention projection system.

FIG. 8 is a diagram of a distribution of light entering the light collecting element of the invention.

FIGS. 9-12 are diagrams of applications of the invention light collecting element in various embodiments.

FIG. 13 is a diagram of a second embodiment of the projection system according to the invention.

### DETAILED DESCRIPTION

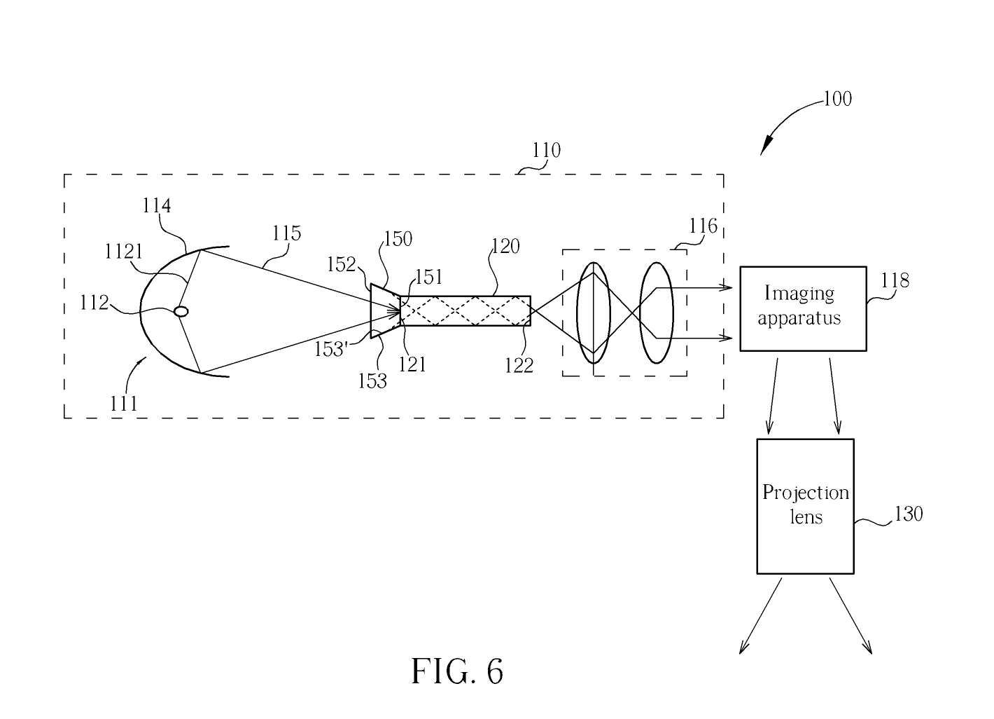

Please refer to FIG. 6. According to a preferred embodiment of the invention, a projection system 100 includes an illumination apparatus 110, an imaging apparatus 118, and a projection lens 130. The illumination apparatus 110 includes a light source 111, a light collecting element 150, a rod integrator 120, and a converging lens array 116.

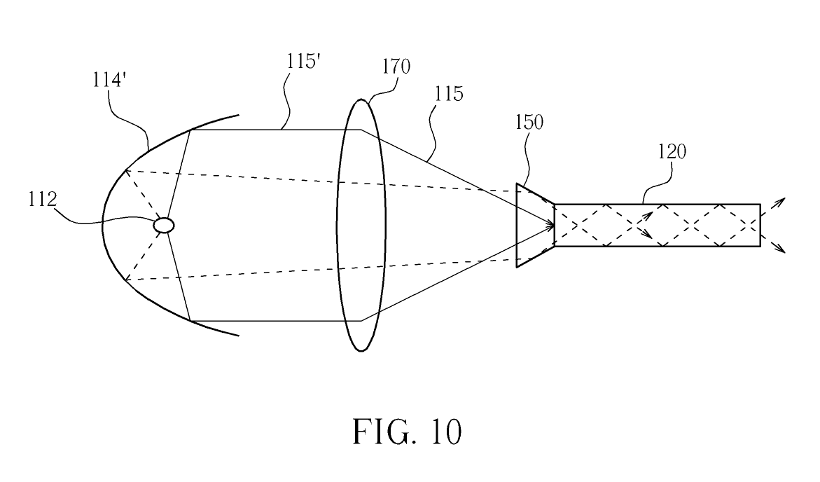

The light source 111 is used to provide a convergent light beam 115, and in the invention, the light source 111 includes an elliptical reflector 114 and a light source 112 set within the elliptical reflector 114. The light source 112 is used to provide a light beam 1121. Through the elliptical reflector 114, the light beam 1121 is reflected and forms a convergent light beam 115. Additionally, please refer to FIG. 10. The light source 111 may include the light source 112, a parabolic reflector 114′, and a condenser lens 170. Light provided by the light source 112 is reflected by the parabolic reflector 114′ and forms a parallel light beam 115′. The parallel light 115′ forms the convergent light beam 115 through the condenser lens 170.

The rod integrator 120 has an incident end 121 and an exit end 122. The convergent light beam 115 is focused at the incident end 121 of the rod integrator 120, and the convergent light beam 115 enters the rod integrator 120 through the incident end 121, and leaves the rod integrator 120 through the exit end 122 after being reflected many times to achieve homogenization of the convergent light beam 115. The rod integrator 120 may have the incident end 121 and the exit end 122 with similar shape and surface area, or the rod integrator 120 can be tapered.

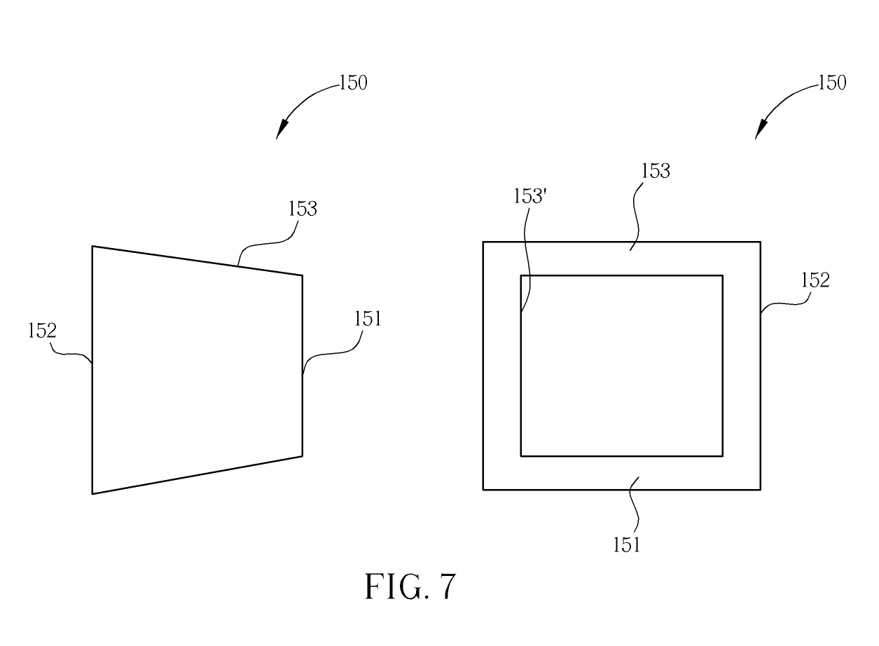

The light collecting element 150 is set between the light source 111 and the rod integrator 120, and is positioned on a light path of the convergent light beam 115. The light collecting element 150 has a first end 151, a second end 152, and at least one side 153 connecting the first end 151 and the second end 152. The light collecting element 150 shrinks from the second end 152 to the first end 151. Thus, a surface area of the second end 152 is greater than a surface area of the first end 151, such that the side 153 connects the second end 152 to the first end 151 with a slope. The first end 151 of the light collecting element 150 faces the rod integrator 120, and is either adjacent to or connected to the incident end 121 of the rod integrator 120. The second end 152 of the light collecting element 150 faces the light source 111 to receive the convergent light beam 115 from the light source 111. At least one side 153 of the light collecting element 150 has a reflective surface 153′, so that the convergent light beam 115 that enters the light collecting element 150 can generate reflections off of the reflective surface 153′ and enter the rod integrator 120. Please refer to FIG. 7. In this embodiment, a shape of the surface of the second end 152 and the first end 151 of the light collecting element 150 is rectangular, and each side 153 has a trapezoidal shape, and when the first end 151 and the incident end 121 are connected directly, the surface of the first end 151 and the surface of the incident end 121 are the same. In addition, the shape of the cross-section of the second end 152 and the first end 151 of the light collecting element 150 may also be semi-circular, circular, octagonal, or another shape.

In addition, the light collecting element 150 may be hollow or solid. When the light collecting element 150 is hollow, at least one internal surface of the side 153 of the light collecting element 150 may be plated with a highly reflective material to form the reflective surface 153′. For example, a glass mirror or an aluminum mirror could be used to cause the light entering the light collecting element 150 to produce reflections through the reflective surface 153′. If the light collecting element 150 is solid, at least one side 153 of the light collecting element 150 may be designed to slant with an angle to form the reflective surface 153′, in order to cause the light entering the light collecting element 150 to produce a total reflection. However, a reflective layer could also be plated onto the side 153 of the solid light collecting element 150 directly to form the reflective surface 153′ to cause the light to generate reflections off of the reflective surface 153′.

The converging lens array 116 is used to scale light that leaves the exit end 122 of the rod integrator 120. The imaging apparatus 118 is used to receive the light scaled by the converging lens array 116 and form an image. The imaging apparatus 118 could be a Texas Instruments (TI) digital micromirror device (DMD). The projection lens is used to project the image onto a surface, such as a screen, to display the image.

In the invention projection system 100, after the convergent light beam 115 provided by the light source 111 enters the light collecting device 150, a part of the convergent light beam 115 passes directly through the light collecting device 150 and enters the rod integrator 120 through the incident end 121 of the rod integrator 120, whereas a part of the convergent light beam reflects off the reflective surface 153′ of the light collecting device 150 before entering the rod integrator 120 through the incident end 121 of the rod integrator 120. Then, after being reflected many times in the rod integrator 120, the light leaves the rod integrator 120 by the exit end 122 of the rod integrator 120 to enter the converging lens array 116 and subsequently the imaging apparatus 118. The imaging apparatus 118 forms the image from the light, and finally projects the image onto the screen through the projection lens 130 to display the image.

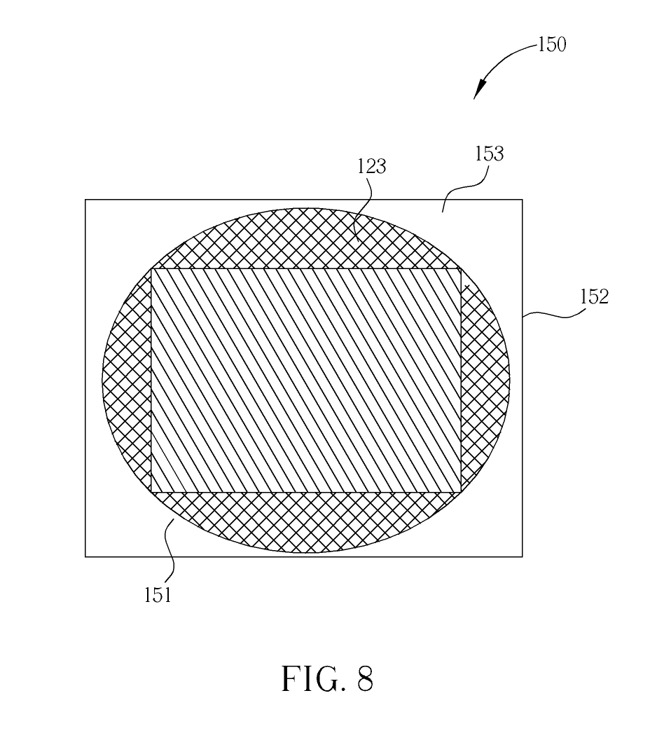

The invention utilizes the light collecting element 150 disposed between the rod integrator 120 and the light source 112. The surface area of the second end 152 of the light collecting element 150 is larger than the first end 151 (and equivalently larger than the incident end 121 of the rod integrator 120). Thus, light (as shown in FIG. 8, light 123) which originally was unable to enter the incident end 121 of the rod integrator 120 can first enter the light collecting element 150 through the second end 152, then enter the incident end 121 of the rod integrator 120 through reflection and guidance of the reflective surface 153′ of the light collecting element 150. In this way, an amount of light entering the incident end 121 is increased. And, the reflection of the reflective surface 153′ can change an angle of incidence of the light entering the incident end 121 of the rod integrator 120, so that an angle of light exiting the rod integrator 120 through the exit end 122 can be adjusted to be within an acceptable range for reception by the imaging apparatus 118. Accordingly, the imaging apparatus 118 can utilize the light and project the light to the screen through the projection lens 130 and display the image, thereby increasing brightness of the projection system 100. Compared to the technique disclosed by U.S. Pat. No. 6,715,880, which must further use an outwardly expanding design in the exit end 222 to change the exit angle of the light, the invention can achieve the same effect by using the light collecting element 150, which has a very simple construction, in addition to the traditional rectangular rod integrator or a tapered rod integrator. Thus, the invention is able to reduce production costs greatly through the design described above.

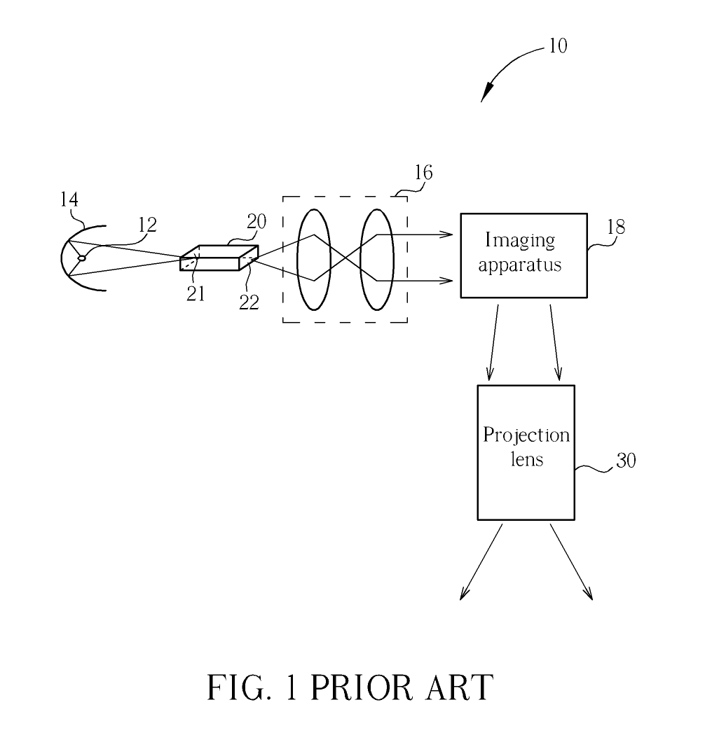

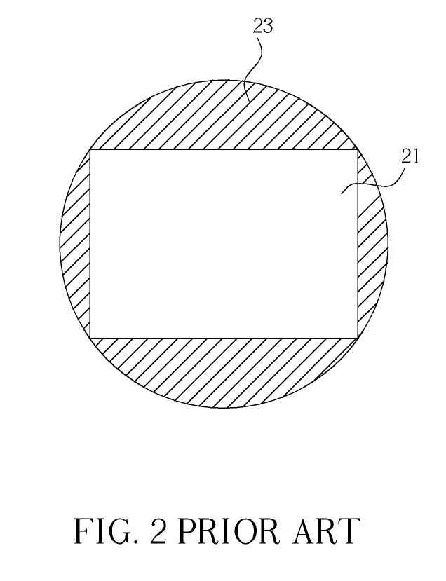

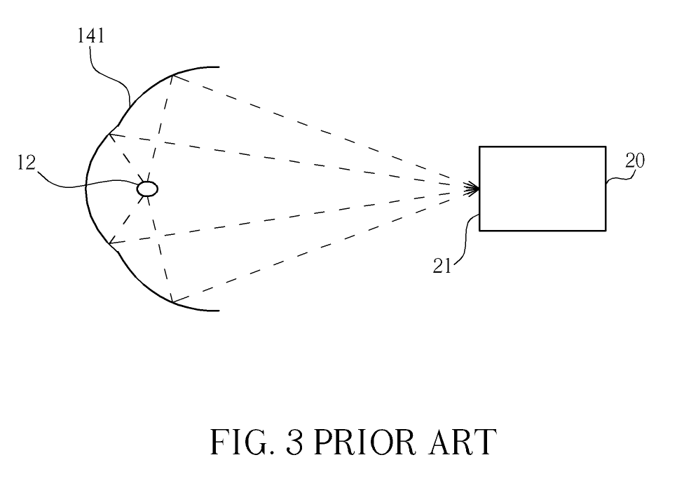

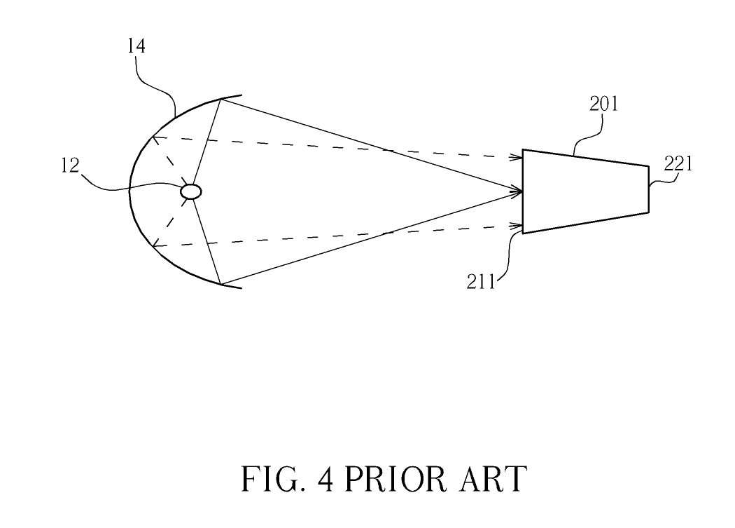

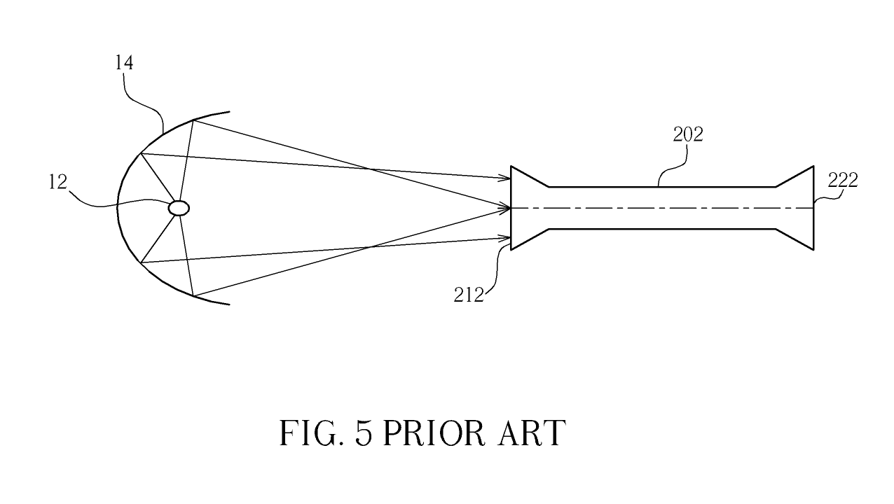

In addition, if ASAP software is used to simulate the invention projection system 100 (as shown in FIG. 6) and the projection system shown in FIG. 1, which does not include the light collecting element 150, an efficiency, i.e. overall brightness of the screen divided by overall brightness of the light source, of the system that does not include the light collecting element 150 is approximately 38.5%. On the other hand, the invention system has an efficiency of approximately 40.8%. Thus, it can be seen that the light collecting element 150 of the invention effectively increases the brightness of the projection system 100.

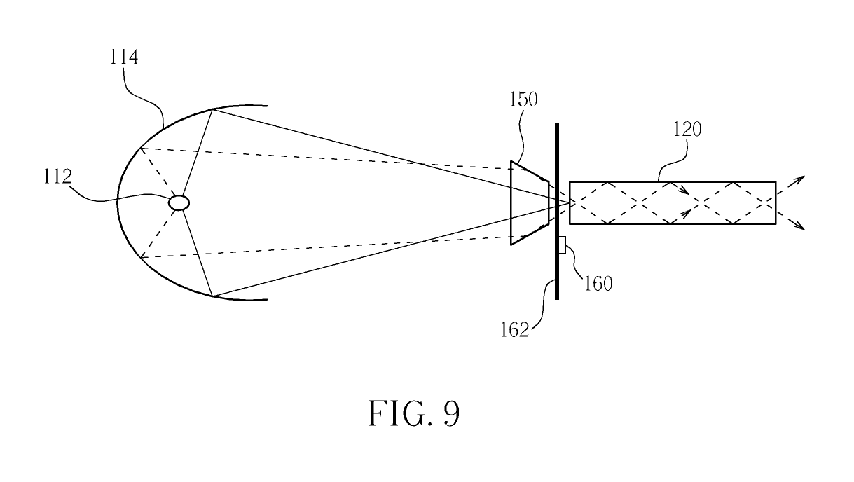

In addition, when the invention projection system 100 is used as a digital light processing (DLP) projection system, as shown in FIG. 9, a color wheel 162 driven by a motor 160 can be disposed between the light collecting element 150 and the rod integrator 120. Color filters of the color wheel 162 provide light of three primary colors (such as red, green, and blue) sequentially to the rod integrator 120.

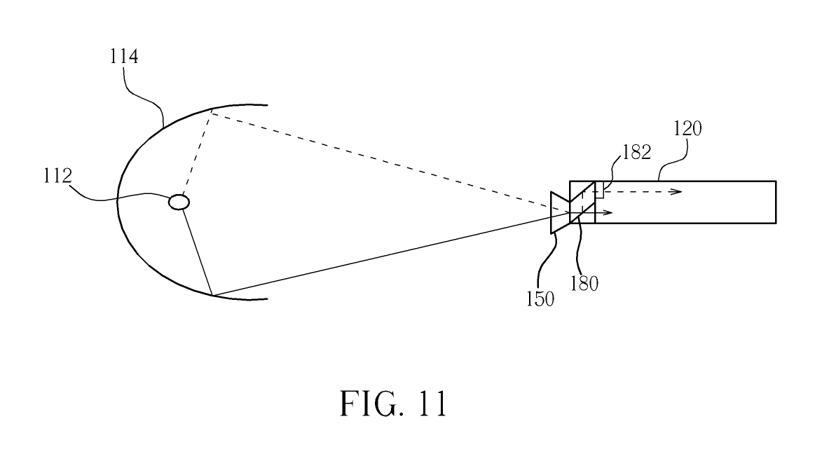

Please refer to FIG. 11. A polarizing transformation unit may be disposed between the light collecting element 150 and the rod integrator 120. The polarizing transformation unit includes a polarization beam splitter 180 and a half-wave plate 182. The polarizing transformation unit allows light of a first polarity, e.g. P-light, to enter the rod integrator 120 directly, but transforms light of a second polarity, e.g. S-light, into light of the first polarity through the half-wave plate 182 before entering the rod integrator 120, such that the light entering the rod integrator 120 is polarized light.

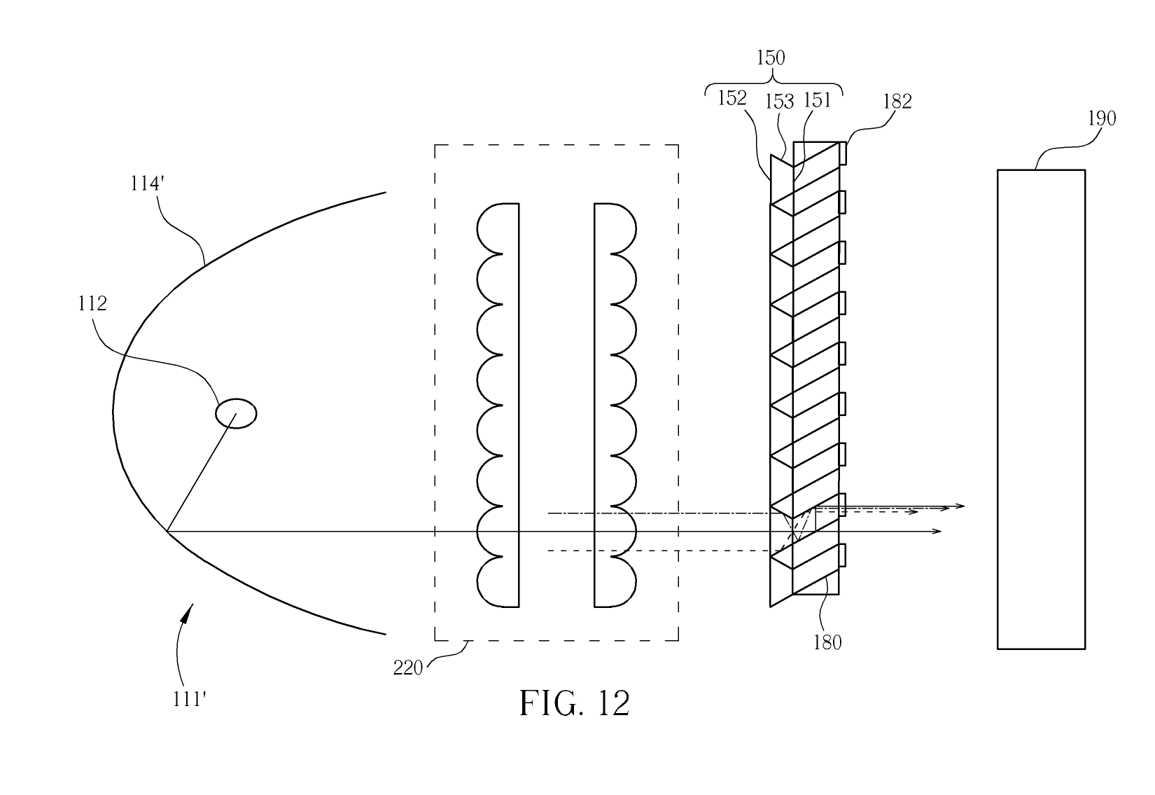

Please refer to FIG. 12, which shows a second embodiment of the invention wherein the light collecting element 150 is used in a projection system that has a liquid crystal display (LCD) panel 190 as an imaging apparatus. The second embodiment is different from the embodiment described above in that: the second embodiment replaces the rod integrator 120 with a lens array 220, and a light source 111′ includes the light source 112 and the parabolic reflector 114′. The second embodiment further includes a plurality of light collecting elements 150. The plurality of light collecting elements 150 are disposed on a side of the lens array 220 that is away from the light source 111′, such that the lens array 220 is disposed between the light source 111′ and the light collecting element 150. The plurality of light collecting elements 150 are arranged in an array corresponding to the lens array 220. Each light collecting element 150 has a second end 152 facing the light source 111′, a first end 151 corresponding to the second end 152, and at least one side 153 connecting the first end 151 and the second end 152. Each light collecting element 150 shrinks from the second end 152 to the first end 151. The side 153 of the light collecting element 150 has at least one reflective surface for reflecting light that enters the light collecting element 150. Light provided by the light source 112 is reflected by the parabolic reflector 114′ to provide a parallel light to the lens array 220. After being homogenized by the lens array 220, and after being received by the plurality of light collecting elements 150, the light enters a polarizing transformation unit that is disposed at an end of the light collecting element 150 and away from the light source 111′. The polarizing transformation unit includes a plurality of polarization beam splitters 180 and a plurality of half-wave plates 182. The polarizing transformation unit provides polarized light to the LCD panel 190, utilizing the light collecting element 150 to improve brightness of the projection system 100. The function and structure of the light collecting element 150 of the second embodiment is similar to the light collecting element 150 described in the preferred embodiment, therefore the detailed description thereof will not be illustrated herein.

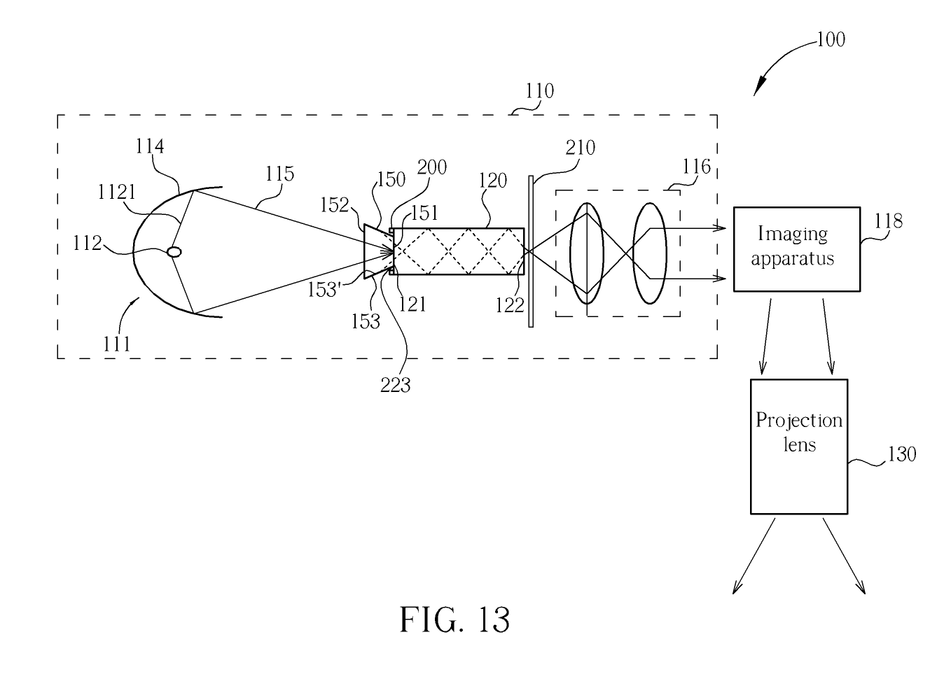

Please refer to FIG. 13, which is a diagram of a second embodiment of the projection system 100 according to the invention. In the second embodiment, the projection system 100 further includes a color wheel 210, and the incident end 121 of the rod integrator 120 includes a reflective surface 200, which defines an aperture 223 facing the first end 151 of the light collecting element 150. The internal side of the reflective surface 200 is reflective. The color wheel 210 selectively transmits at least one color of light, and reflects all other colors of light into the rod integrator 120. The reflective surface 200 is utilized for reflecting unusable light back into the rod integrator 120 to increase luminescent efficiency. For example, when the color wheel 210 transmits red light, the color wheel 210 simultaneously reflects green light and blue light toward the incident end 121 of the rod integrator 120. The reflected green light and blue light are then reflected back by the reflective surface 200. When the color wheel 210 transmits green light, the green light reflected by the reflective surface 200 is transmitted in addition to green light originally incident on the color wheel 210. Likewise, when the color wheel 210 transmits blue light, the blue light reflected by the reflective surface 200 is transmitted along with blue light originally incident on the color wheel 210. In this way, the luminescent efficiency of the projection system 100 is improved significantly. The reflective surface 200 can be a glass or aluminum mirror plated onto the rod integrator 120.

In summary, the invention projection system 100 uses the light collecting element 150 and the reflective surface 200 to increase the luminescent efficiency of the projection system 100.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection system comprising:
an illumination apparatus comprising:
a light source for providing a parallel light beam;
a lens array;
a plurality of light collecting elements disposed at a side of the lens array away from the light source, the light collecting elements arranged in an array corresponding to the lens array, the each light collecting element having a second end facing the light source, a first end corresponding to the second end, and at least one side connected between the first end and the second end, the each light collecting element shrinking from the second end to the first end, the side of the light collecting element having at least one reflective surface for reflecting a portion of the light beam entering the light collecting element; and
a converging lens array for scaling the light beam exiting the light collecting element;
an imaging apparatus for receiving the light beam scaled by the converging lens array and forming an image; and
a projection lens for projecting the image to a surface.

2. The projection system of claim 1, wherein the imaging apparatus is a liquid crystal display (LCD) panel.

3. The projection system of claim 2 further comprising a polarizing transformation element disposed at an end of the light collecting elements away from the light source, the polarizing transformation element comprising a plurality of polarization beam splitters and a plurality of half-wave plates.
